(19) United States
(12) Patent Application Publication
(10) Pub. No.: US 2022/0253862 A1
(43) Pub. Date: Aug. 11, 2022

(54) FACE BASED PAYMENT SYSTEM AND METHODS

(71) Applicant: POPID, INC., Diamond Bar, CA (US)

(72) Inventors: John Miller, Santa Monica, CA (US); Sean Olson, Pacific Palisades, CA (US); Kourosh Gohar, Brentwood, CA (US)

(21) Appl. No.: 17/667,357

(22) Filed: Feb. 8, 2022

Related U.S. Application Data
(60) Provisional application No. 63/146,945, filed on Feb. 8, 2021.
(60) Provisional application No. 63/146,954, filed on Feb. 8, 2021.

(51) Int. Cl. G06Q 20/40; G06Q 20/32

(52) U.S. Cl. CPC G06Q 20/40145; G06Q 20/322; G06Q 20/3267

(57) ABSTRACT

A system for face-based payment includes two screens coupled together. One screen is configured to display a payment interface to a cashier. The other screen is configured to display a payment interface to a customer and to receive camera data indicative of the customer. One or more processors are configured to perform a facial recognition operation in response to receiving the camera data indicative of the customer and to perform a payment transaction in response to performing the facial recognition operation. The screens may be coupled to a transparent barrier positioned between the screens and that extends beyond the boundaries of the screens. Other embodiments are described and claimed.

### CROSS-REFERENCE TO RELATED APPLICATIONS

The present application claims priority under 35 U.S.C. § 119(e) to U.S. Provisional Application Ser. No. 63/146,945, filed Feb. 8, 2021, and to U.S. Provisional Application Ser. No. 63/146,954, filed Feb. 8, 2021, the entire disclosure of each of which is hereby incorporated by reference.

### BACKGROUND

Facial recognition technology has become increasingly accurate and fast. PopID, for example, is a two-sided marketplace that allows merchants to authenticate customers in retail transactions at the point of sale. Customers register for PopID and can then use the service to pull up loyalty accounts and make payments using facial recognition. For example, after a cashier enters a customer's purchase into an interface of a face-based payment system (e.g., a touchscreen of a tablet computing device), an optical camera positioned on the back of the tablet scans the customer's face. The payment system then may determine an identity of the customer based on the image of the face and communicate with a remote computing device (e.g., a server) to process payment by the customer for the transaction based on his or her identity.

In such transactions, the customer and the cashier are arranged face-to-face in close proximity so that the cashier can access the touchscreen of the tablet and the customer is within range of the optical camera on the back of the tablet. However, recent global outbreaks of infectious diseases, such as COVID-19, have led to a rise in the use of transparent barriers (“sneeze guards”) to separate cashier and customer and help protect against the spread of disease. Where such sneeze guards are used, known devices for holding a tablet of a face-based payment system, such as pedestal-type stands, can be impractical and/or fail to properly position the tablet for easy use by both customer and cashier.

### SUMMARY

According to one aspect, a system for face-based payment comprises a first screen configured to display a payment interface to a cashier; a second screen coupled to the first screen and configured to display a payment interface to a customer and to receive camera data indicative of the customer; and one or more processors to perform a facial recognition operation in response to receipt of the camera data indicative of the customer and perform a payment transaction in response to performance of the facial recognition operation. In some embodiments the first screen is wirelessly coupled to the second screen via a wireless communication link.

In some embodiments, the first screen is mechanically coupled to the second screen. In some embodiments, the first screen is parallel to the second screen, wherein the first screen faces a first direction extending away from the second screen, and wherein the second screen faces a second direction opposite the first direction. In some embodiments, the first screen and the second screen are coupled to a transparent barrier positioned between the first screen and the second screen and that extends beyond the boundaries of the first screen and the second screen.

In some embodiments, the second screen are pivotally coupled via a hinge. In some embodiments, the first screen and the second screen are coupled to a stand positioned between the first screen and the second screen.

In some embodiments, the one or more processors are further configured to receive camera data indicative of a gesture performed by the customer and determine a parameter of the payment transaction based on the gesture performed by the customer. In some embodiments, the parameter of the payment transaction comprises a transaction authorization or a tip amount.

According to another aspect, an apparatus for mounting a tablet computing device in a face-based payment system comprises a rectangular frame comprising a hard transparent material and sized to extend around a perimeter off the tablet computing device; a pair of side retaining brackets coupled to the frame, wherein each side retaining bracket is coupled to the frame adjacent to a long edge of the frame; and a bottom retaining bracket coupled to the frame adjacent to a short edge of the frame. The frame, the side retaining brackets, and the bottom retaining bracket cooperate to define a slot sized to receive the tablet computing device.

In some embodiments, the apparatus further comprises a transparent barrier, wherein the side retaining brackets are bonded to the transparent barrier, and wherein the transparent barrier cooperates with the frame, the side retaining brackets, and the bottom retaining bracket to define the slot. In some embodiments, the frame and the transparent barrier comprise a transparent polymer material. the transparent polymer material comprises polycarbonate or acrylic.

In some embodiments, the frame comprises a perimeter, and wherein an edge of the perimeter defines a cutout, wherein the cutout is configured to surround an optical camera of the tablet computing device when the tablet computing device is positioned in the slot. In some embodiments, the frame further defines a central opening, wherein the central opening is configured to surround a touchscreen of the tablet computing device when the tablet computing device is positioned in the slot.

According to another aspect, a system for face-based payment comprises a tablet computing device; a transparent barrier configured to separate a cashier and a customer; and an apparatus coupled to the transparent barrier on a side of the transparent barrier accessible to the cashier, wherein the apparatus and the transparent barrier cooperate to define a slot that is sized to receive the tablet computing device. When the tablet computing device is positioned in the slot, a processor of the tablet computing device is configured to receive camera data indicative of the customer from a camera coupled to the tablet computing device, perform a facial recognition operation in response to receipt of the camera data indicative of the customer, and perform a payment transaction in response to performance of the facial recognition operation. In some embodiments, the tablet computing device comprises a display surface and a back surface, wherein the display surface faces the cashier, and wherein the back surface comprises the camera and faces the customer.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a perspective view of at least one embodiment of a system for face-based payment;

FIG. 2 is a perspective view from another angle of the system of FIG. 1;

FIG. 3 is a perspective view of at least one embodiment of another system for face-based payment;

FIG. 4 is a perspective view from another angle of the system of FIG. 3;

FIGS. 5-8 are perspective views of at least one embodiment of another system for face-based payment;

FIG. 9 is a schematic diagram of at least one embodiment of another system for face-based payment; and

FIG. 10 is a simplified block diagram of at least one embodiment of the systems of FIGS. 1-9.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The present invention is a module comprised of two connected screens and is used as a face based payment system. The two screens can be physically connected, or communicate through wireless mechanisms such as Bluetooth® or other personal area networks. If the screens are physically connected, the screens can be rotated using a mechanism such as a hinge.

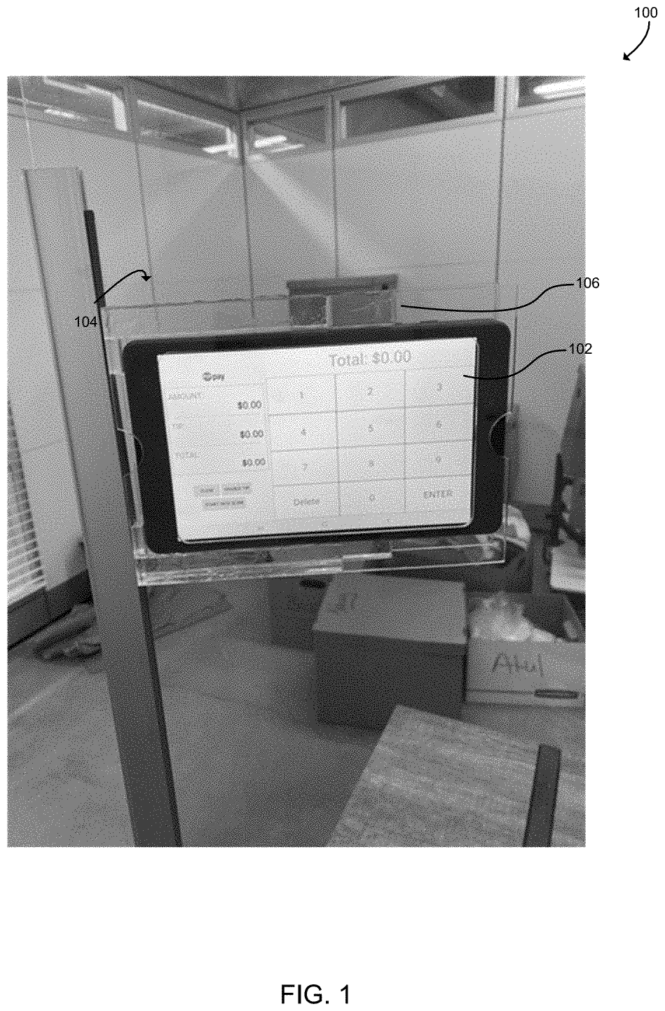

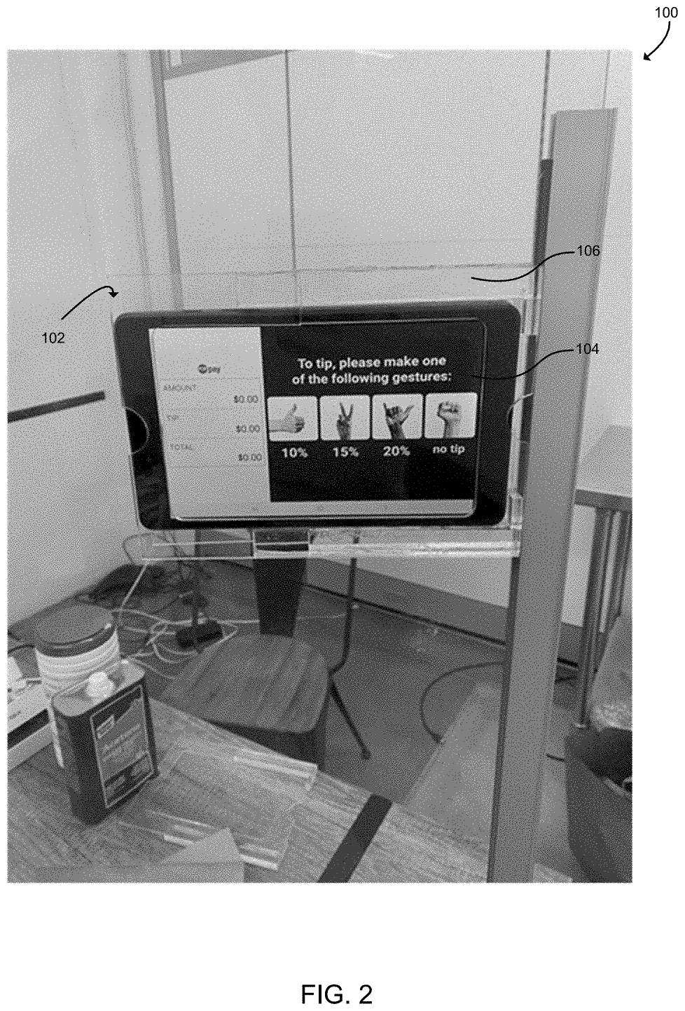

In another embodiment of the invention, the screens of the face based payment system are arranged such that they are aligned and are parallel. In this configuration, the module can be integrated into a free standing barrier such as sneeze guard and used as a face based payment system. Referring now to FIGS. 1 and 2, a system 100 including two connected screens is illustrated. FIG. 1 shows a merchant facing screen 102 on a sneeze guard 106, and FIG. 2 shows a consumer facing screen 104 on the sneezeguard 106. Accordingly, both screens 102, 104 may be attached to the sneeze guard 106 such that the module is positioned for easy use by both customer and cashier.

In another embodiment of the invention, the module may be connected to point of sale (POS) hardware such that the camera on the consumer facing screen can capture the faces of all different sized customers.

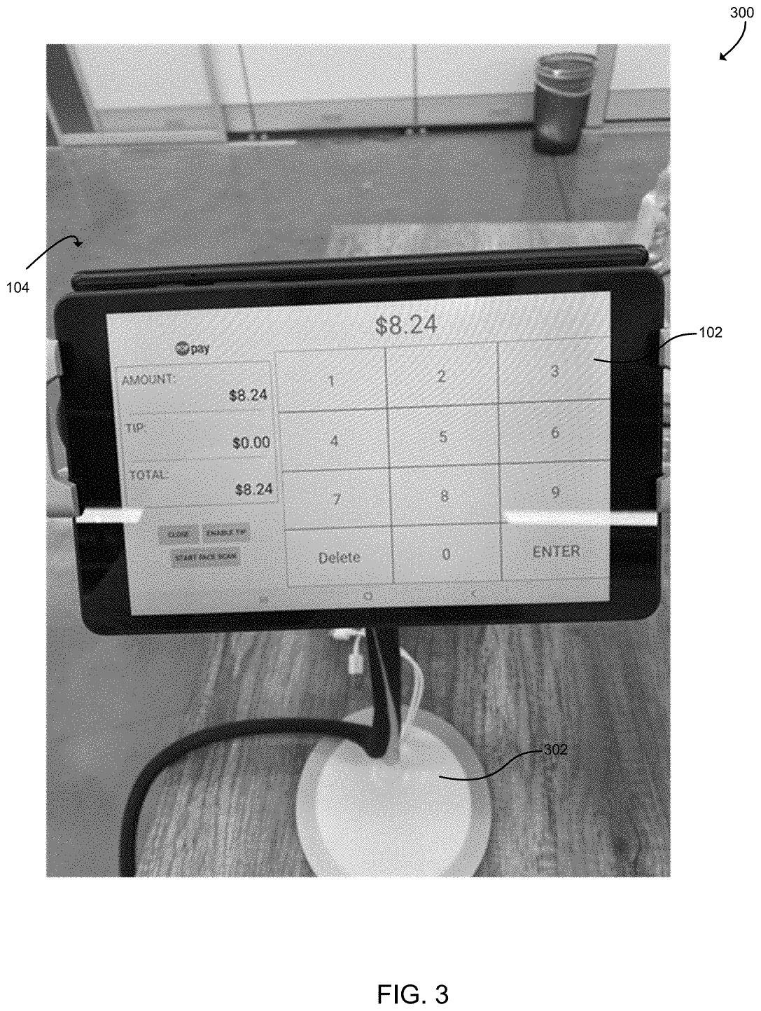

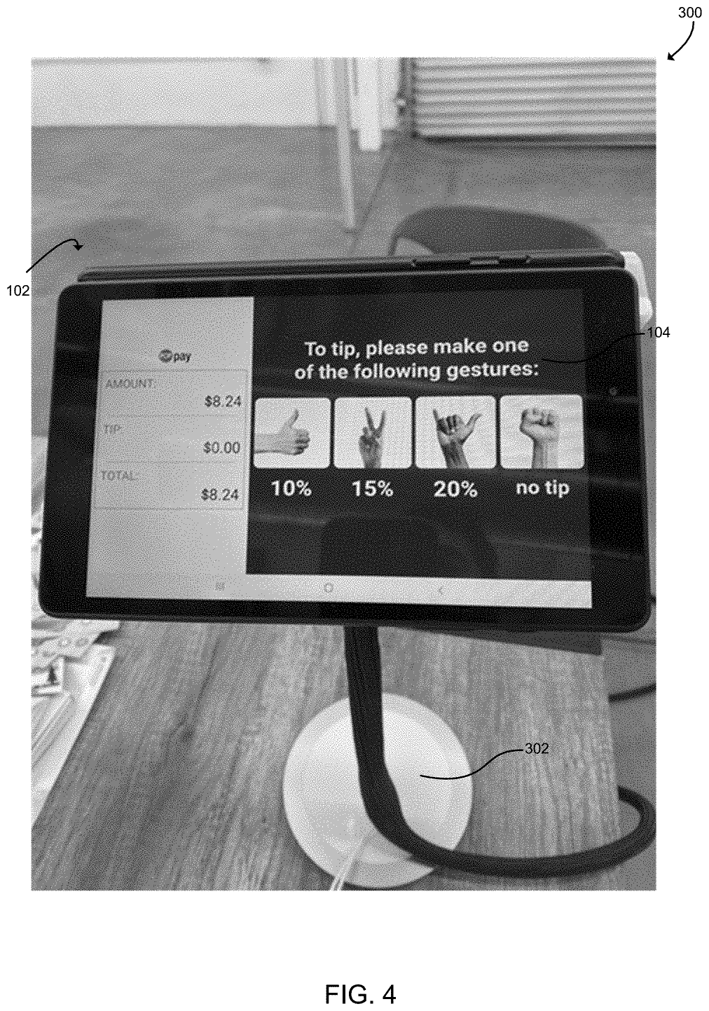

In another embodiment, the screens 102, 104 are arranged such that they converge at an approximately 45 degree angle. In this configuration, the module can be mounted on a stand and used as face-based payment system. Referring now to FIGS. 3 and 4, a system 300 including two connected screens is illustrated. FIG. 3 shows the merchant-facing screen 102 on a stand, and FIG. 4 shows the consumer-facing screen 104 on a stand.

Another embodiment of the invention is related to an apparatus for attaching a tablet computing device (e.g., a merchant-facing screen 102 device) to a sheer vertical surface, such as a sneeze guard, so that a cashier or other worker on one side of the sneeze guard can easily use the touchscreen on the front of the tablet and a customer on the other side of the sneeze guard can position himself or herself within range of an optical camera on the back of the tablet for facial recognition.

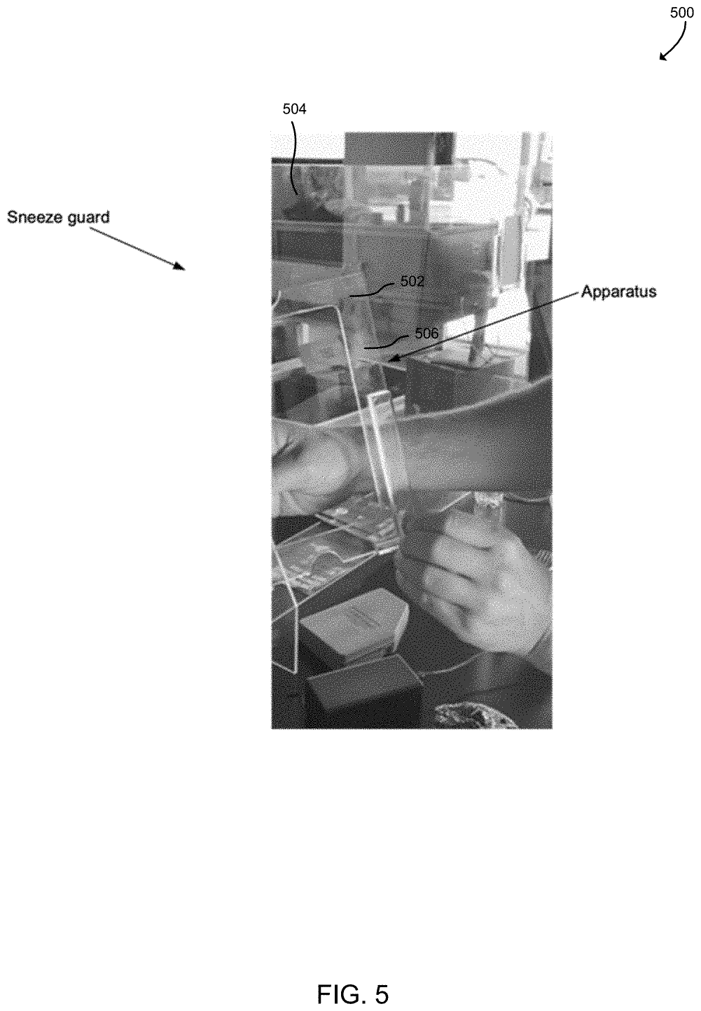

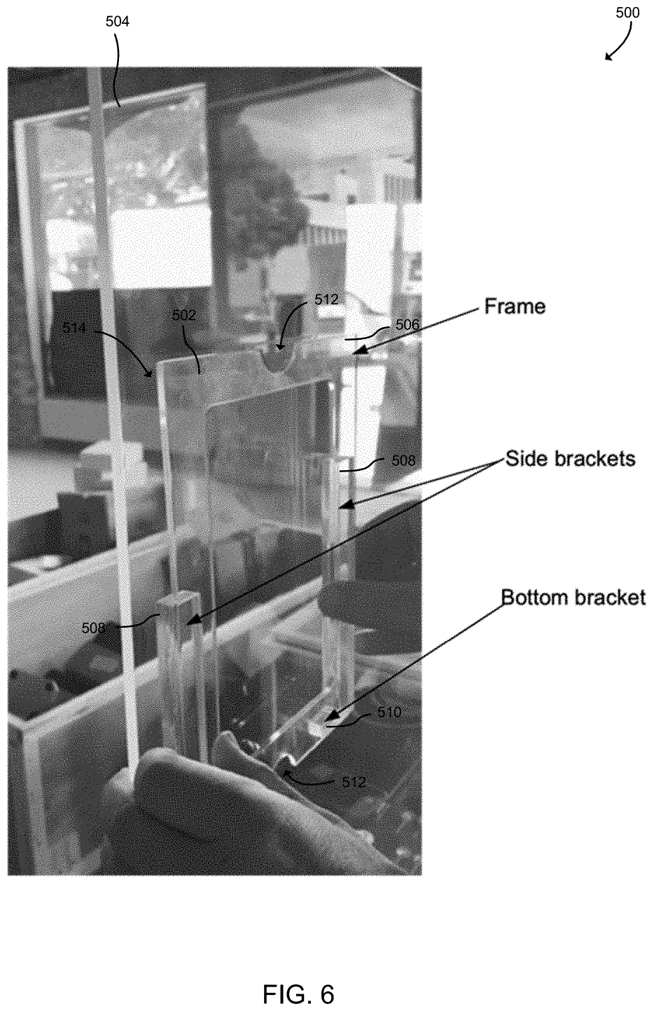

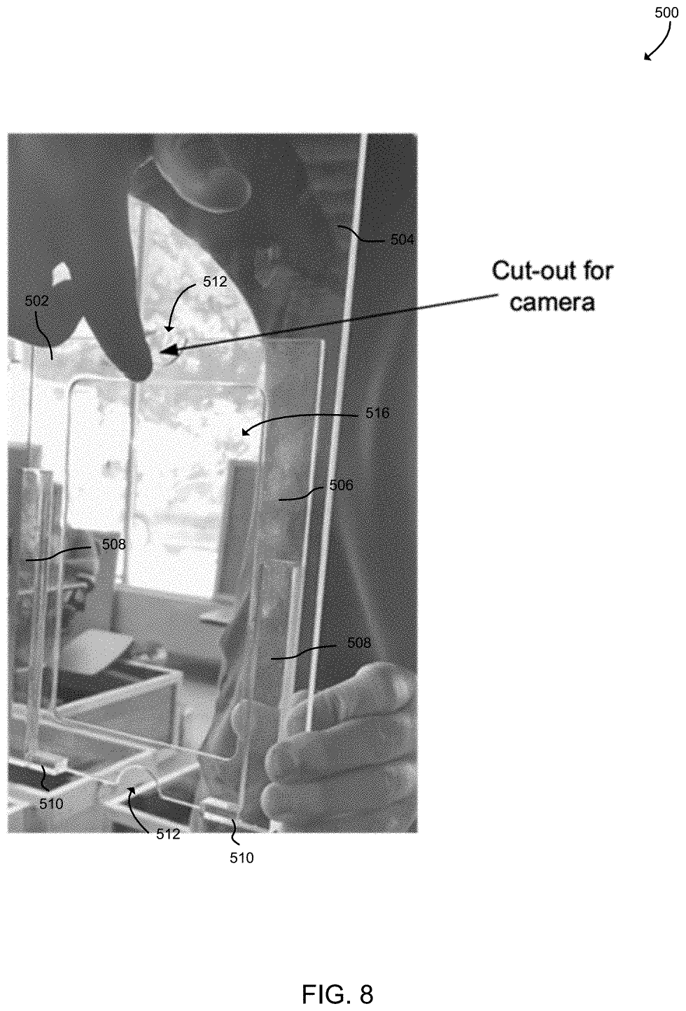

Referring now to FIGS. 5-8, in some embodiments, an apparatus 502 of a system 500 for attaching a tablet computing device 102 to a sheer vertical surface, such as a sneeze guard 504, comprises a frame 506. The frame 506 may be made from a polymer (e.g., acrylic or polycarbonate) or another suitable material and is dimensioned to extend around a bezel or other perimeter of a major surface of the tablet. The material of the frame 506 is preferably clear to enable unobstructed viewing of the tablet. The apparatus 502 further comprises two side retaining brackets 508 and a bottom bracket 510, as shown in FIG. 6. In some embodiments, the frame of the apparatus may define one or more cut-outs 512 positioned to align with the camera of the tablet as shown in FIG. 8, thereby reducing the amount of material between the camera and the customer and enabling the camera to obtain a clearer image. The apparatus 502 is attached to a clear sneeze guard 504 via adhesive (e.g., epoxy) or another suitable mechanism. For example, an adhesive may be applied to the exposed major surfaces of the side brackets 508, which are then directly applied to the sneeze guard 504.

With the apparatus 502 attached to the sneeze guard 504, a slot 514 is defined between the frame 506 and the sneeze guard 504 as shown in FIG. 6. The tablet 102 can be slid into the slot 514 between the sneeze guard 504 and the apparatus 502, from the top of the apparatus 502 on the cashier's side of the sneeze guard 504, such that the tablet 102 is retained within the frame 506 by the bottom and side brackets 508, 510. The apparatus 502 also includes a central opening 516. When the tablet 102 is inserted into the slot 514, the touchscreen of the tablet 102 is accessible through the opening 516.

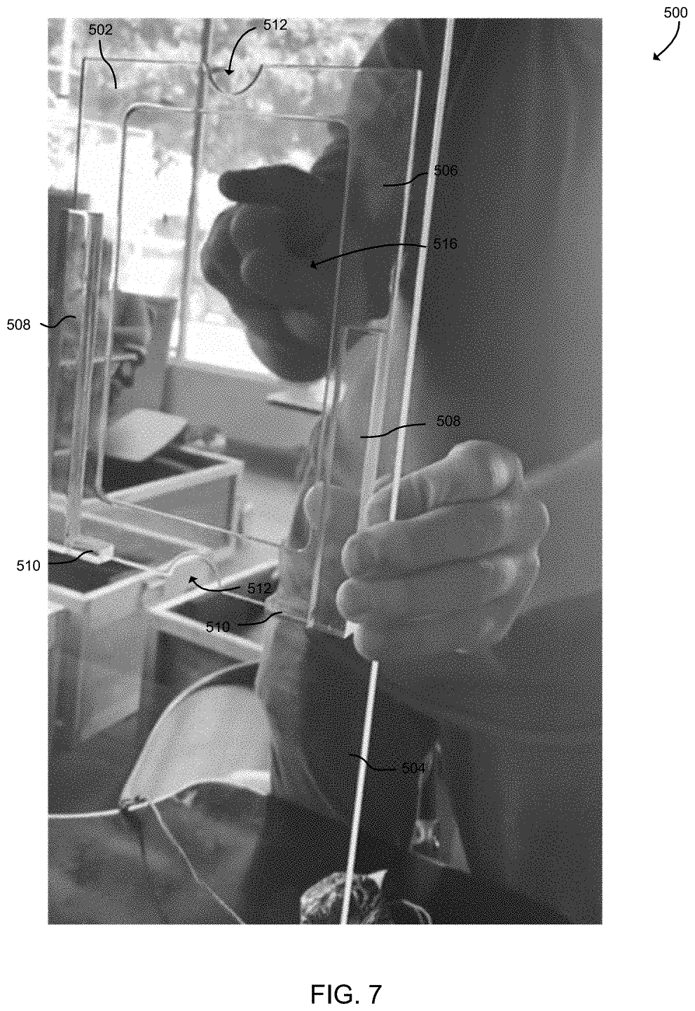

With the apparatus 502 attached to the sneeze guard 504 and the tablet 102 slid into the apparatus 502, the touchscreen of the tablet 102 faces the cashier for his or her use as shown in FIG. 7, and the camera positioned on the opposite side of the tablet 102 faces the customer as shown in FIG. 8. The tablet 102 thus can be used to capture an image of the customer's face for use in a face-based payment system comprising the tablet 102 while maintaining a protective barrier between the customer and cashier.

In some embodiments, a payment system comprises gesture controls that may be used by the customer during the payment process. In such embodiments, gestures made by the customer comprise user input that is recognized by the payment system's camera. This input may convey information such as the customer's acceptance of the amount of a charge, an amount or percentage of a tip to add to an order, an authorization to be recognized by a face-based payment system such as PopPay, or the like. Where the gesture input corresponds to an amount or percentage of a tip, the customer may use a thumbs-up/thumbs-down gesture to indicate that he or she accepts or declines a certain tip amount; alternatively, the customer may move a finger through the air to select a specific tip amount. Where the gesture indicates the customer's authorization to be recognized by a face-based payment system, such a gesture may aid compliance with laws and regulations that forbid unrequested biometric recognition. In any such examples, gesture controls for the payment system advantageously enable customer feedback and input while being contact-free. Such gesture-enabled payment systems may be used with one or more embodiments of the apparatus described herein.

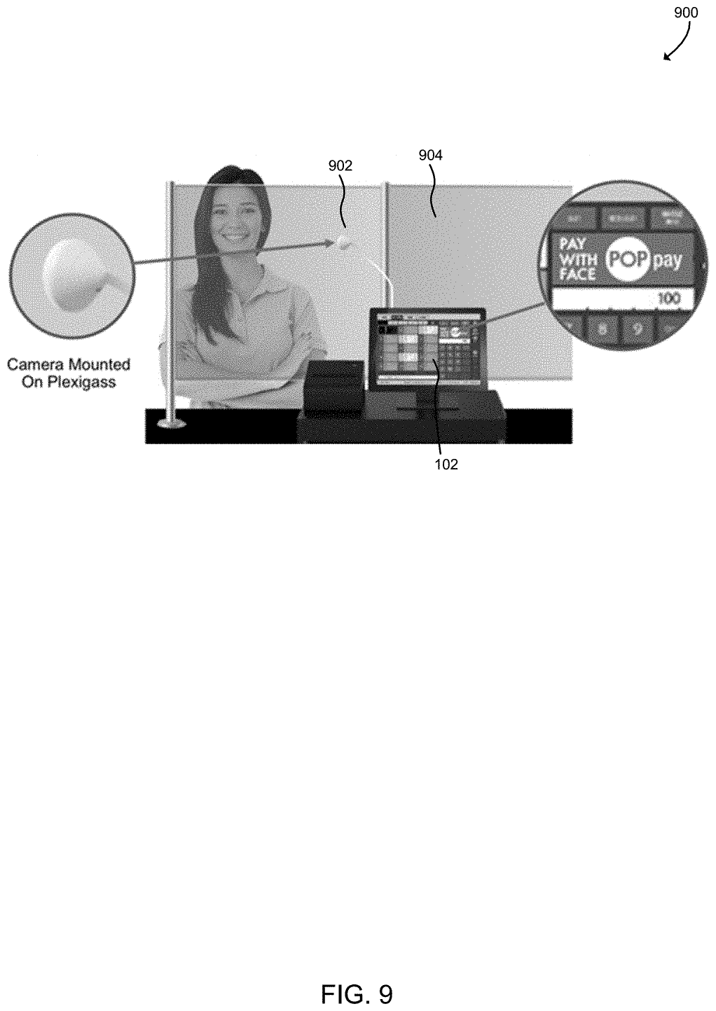

Referring now to FIG. 9, a payment system 900 includes a stand-alone camera 902 (i.e., a camera not integrated into a tablet) mounted to a sneeze guard 904. In this embodiment, the camera 902 is connected to a point-of-sale (POS) machine 102 positioned on a counter on the cashier's side of the sneeze guard 904. A computer on the POS machine 102 or a computer connected to the POS machine 102 is configured to execute image processing (e.g., face cropping of a closest person and liveness filtering) of image(s) captured by the stand-alone camera 902, and send the cropped image of the customer's face to a cloud database for matching to the customer's account.

In another embodiment (not pictured), a payment system (e.g., a touch panel screen of a tablet computing device), is embedded within a sneeze guard. For example, a manufacturer of the touch panel screen may extend a plastic or glass frame of the device far beyond the touch panel screen to form a sneeze guard comprising the device. In this manner, when an enterprise retailer buys such a sneeze guard, there is an embedded payment device built inside of the sneeze guard. In this embodiment, the embedded touch panel screen may include options for both cashier and customer to touch it. Additionally, or alternatively, the embedded payment device may include near-field communication (NFC) components enabling the customer to hold up an electronic device, such as a phone, to the payment device to pay. As described above with respect to other embodiments, the device of this embodiment may comprise camera(s) facing the cashier and/or customer. In any embodiments, a touch panel screen may be a transparent LCD that may be see-through if the device is not being used.

In any embodiments, algorithms and/or image processing may be applied by a computing device of the systems described herein to eliminate the distortion of a facial image that may be caused by the plexiglass of the sneeze guard and to enable improved facial recognition. Additionally, or alternatively, a computing device of the systems described herein may execute a process whereby an algorithm selects only an image of person closest to the camera (e.g., by size, focus, lighting) and all other faces are cut out so that facial recognition is not performed on anyone who has not requested it. In any embodiments, a computing device of the systems described herein may execute a process by which a time stamp associated with the payment may be later associated with a customer's order data from a POS machine to link the data and enable improved product recommendations later on.

In any embodiments, a payment system may be enabled for palm recognition as second-factor authentication. Palm print recognition can be used to identify a person based on the lines, wrinkles and ridges of the palm print. Palm prints advantageously may be used because they generally do not change during an individual's life and because they are unique to each person. Moreover, palm recognition tends not to cause feelings of uneasiness in the person having his or her palm scanned, which may be in contrast to other types of biometric scanning. In the context of the embodiments described herein, palm scanning may be done using an RGB camera and could, in some implementations, employ 3D anti-spoofing, such as binocular anti-spoofing, to ensure that an actual hand is being scanned and not a picture. Second factor authentication may be advantageous in various instances, such as where fraud is suspected, and/or based on historical user behavior such as a charge from a retailer in an area that a user has never visited.

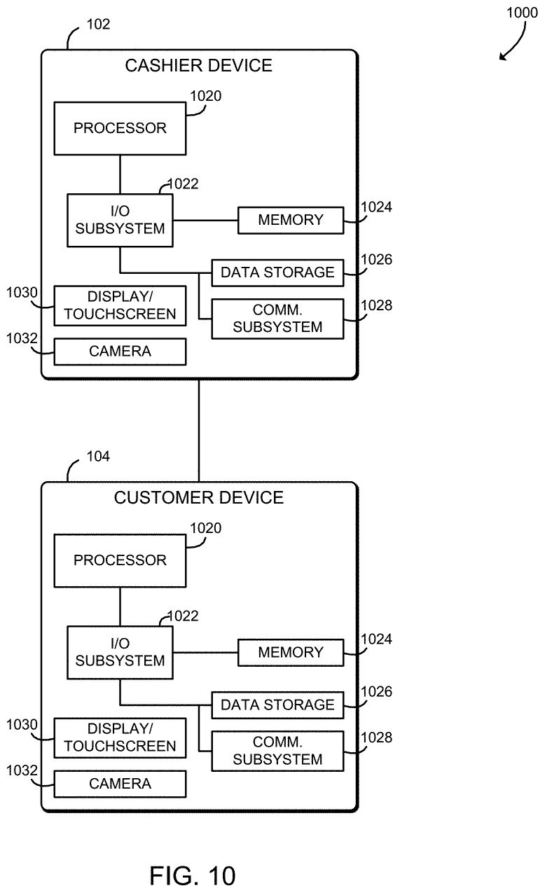

Referring now to FIG. 10, an illustrative system 1000 for face pay includes a cashier device 102 coupled to a customer device 104 as described above. Each of the casher device 102 and the customer device 104 may be embodied as any type of device capable of performing the functions described above in connection with any of FIGS. 1-9. For example, each of the casher device 102 and the customer device 104 may be embodied as, without limitation, a tablet computer, a point of sale device, a smartphone, a consumer electronic device, a network appliance, a web appliance, a laptop computer, a desktop computer, a server, a rack-mounted server, a blade server, a workstation, a distributed computing system, a multiprocessor system, and/or any other computing device capable of performing the functions described herein. As shown in FIG. 10, each of the cashier device 102 and the customer device 104 includes a processor 1020, an I/O subsystem 1022, memory 1024, a data storage device 1026, and a communication subsystem 1028. Of course, the cashier device 102 and/or the customer device 104 may include other or additional components, such as those commonly found in a tablet computer (e.g., various input/output devices), in other embodiments. Additionally, in some embodiments, one or more of the illustrative components may be incorporated in, or otherwise form a portion of, another component. For example, the memory 1024, or portions thereof, may be incorporated in the processor 1020 in some embodiments.

The processor 1020 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 1024 may be embodied as any type of volatile or non-volatile memory or data storage capable of performing the functions described herein. In operation, the memory 1024 may store various data and software used during operation of the cashier device 102 and/or the customer device 104 such as operating systems, applications, programs, libraries, and drivers. The memory 1024 is communicatively coupled to the processor 1020 via the I/O subsystem 1022, which may be embodied as circuitry and/or components to facilitate input/output operations with the processor 1020, the memory 1024, and other components of the order server 102. For example, the I/O subsystem 1022 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 1022 may form a portion of a system-on-a-chip (SoC) and be incorporated, along with the processor 1020, the memory 1024, and other components of the cashier device 102 and/or the customer device 104, on a single integrated circuit chip.

The data storage device 1026 may be embodied as any type of device or devices configured for short-term or long-term storage of data such as, for example, memory devices and circuits, memory cards, hard disk drives, solid-state drives, or other data storage devices. The communication subsystem 1028 of the order server 102 may be embodied as any communication circuit, device, or collection thereof, capable of enabling communications between the cashier device 102, the customer device 104, and/or other remote devices. The communication subsystem 1028 may be configured to use any one or more communication technology (e.g., wireless or wired communications) and associated protocols (e.g., Ethernet, Bluetooth®, Bluetooth Low Energy (BLE), WiMAX, 3G LTE, 5G, etc.) to effect such communication.

As shown, each of the cashier device 102 and the customer device 104 may further include a display/touchscreen 1030 and a camera 1032. Each display 1030 may be embodied as any type of display capable of displaying digital information, such as a liquid crystal display (LCD), a light emitting diode (LED), a plasma display, a cathode ray tube (CRT), or other type of display device. Each display 1030 may be used to display graphics, information screens, user interfaces, or other gaming information. In the illustrative embodiment, each display 1030 also includes or is otherwise coupled to a touchscreen or other input device to receive user input.

Each camera 1032 may be embodied as a digital camera or other digital imaging device integrated with the cashier device 102 and/or the customer device 104 or otherwise communicatively coupled thereto. Each camera 1032 includes an electronic image sensor, such as an active-pixel sensor (APS), e.g., a complementary metal-oxide-semiconductor (CMOS) sensor, or a charge-coupled device (CCD). Each camera 1032 may be used to capture image data including, in some embodiments, capturing still images or video images. In some embodiments, the camera 1032 may include and/or be coupled to additional imaging sensors, such as depth cameras, infrared cameras, infrared emitters, structured light cameras, or other sensors.

Additionally, although illustrated in FIG. 10 as including two computing devices 102, 104 it should be understood that in some embodiments the system 1000 may include a different number and/or arrangement of computing devices. For example, in some embodiments, the system 1000 may include a single device (e.g., a point of sale device) coupled to multiple displays 1030. As another example, and as shown above in connection with FIGS. 5-9, in some embodiments the system 1000 may include a single cashier device 102 that performs facial recognition of the customer using the camera 132.

1. A system for face-based payment comprises:
a first screen configured to display a payment interface to a cashier;
a second screen coupled to the first screen and configured to display a payment interface to a customer and to receive camera data indicative of the customer; and
one or more processors to (i) perform a facial recognition operation in response to receipt of the camera data indicative of the customer and (ii) perform a payment transaction in response to performance of the facial recognition operation.

2. The system of claim 1, wherein the first screen is wirelessly coupled to the second screen via a wireless communication link.

3. The system of claim 1, wherein the first screen is mechanically coupled to the second screen.

4. The system of claim 3, wherein the first screen is parallel to the second screen, wherein the first screen faces a first direction extending away from the second screen, and wherein the second screen faces a second direction opposite the first direction.

5. The system of claim 3, wherein the first screen and the second screen are coupled to a transparent barrier positioned between the first screen and the second screen and that extends beyond the boundaries of the first screen and the second screen.

6. The system of claim 3, wherein the first screen and the second screen are pivotally coupled via a hinge.

7. The system of claim 3, wherein the first screen and the second screen are coupled to a stand positioned between the first screen and the second screen.

8. The system of claim 1, wherein the one or more processors are further configured to (i) receive camera data indicative of a gesture performed by the customer and (ii) determine a parameter of the payment transaction based on the gesture performed by the customer.

9. The system of claim 8, wherein the parameter of the payment transaction comprises a transaction authorization or a tip amount.

10. An apparatus for mounting a tablet computing device in a face-based payment system comprises:
a rectangular frame comprising a hard transparent material and sized to extend around a perimeter off the tablet computing device;
a pair of side retaining brackets coupled to the frame, wherein each side retaining bracket is coupled to the frame adjacent to a long edge of the frame; and
a bottom retaining bracket coupled to the frame adjacent to a short edge of the frame;
wherein the frame, the side retaining brackets, and the bottom retaining bracket cooperate to define a slot sized to receive the tablet computing device.

11. The apparatus of claim 10, further comprising a transparent barrier, wherein the side retaining brackets are bonded to the transparent barrier, and wherein the transparent barrier cooperates with the frame, the side retaining brackets, and the bottom retaining bracket to define the slot.

12. The apparatus of claim 11, wherein the frame and the transparent barrier comprise a transparent polymer material.

13. The apparatus of claim 12, wherein the transparent polymer material comprises polycarbonate or acrylic.

14. The apparatus of claim 10, wherein the frame comprises a perimeter, and wherein an edge of the perimeter defines a cutout, wherein the cutout is configured to surround an optical camera of the tablet computing device when the tablet computing device is positioned in the slot.

15. The apparatus of claim 10, wherein the frame further defines a central opening, wherein the central opening is configured to surround a touchscreen of the tablet computing device when the tablet computing device is positioned in the slot.

16. A system for face-based payment comprises:
a tablet computing device;
a transparent barrier configured to separate a cashier and a customer; and
an apparatus coupled to the transparent barrier on a side of the transparent barrier accessible to the cashier, wherein the apparatus and the transparent barrier cooperate to define a slot that is sized to receive the tablet computing device;
wherein when the tablet computing device is positioned in the slot, a processor of the tablet computing device is configured to (i) receive camera data indicative of the customer from a camera coupled to the tablet computing device, (ii) perform a facial recognition operation in response to receipt of the camera data indicative of the customer, and (iii) perform a payment transaction in response to performance of the facial recognition operation.

17. The system of claim 16, wherein the tablet computing device comprises a display surface and a back surface, wherein the display surface faces the cashier, and wherein the back surface comprises the camera and faces the customer.
